(19) United States
(12) Patent Application Publication
(10) Pub. No.: US 2025/0067500 A1
(43) Pub. Date: Feb. 27, 2025

(54) Enhanced Insulated Door

(71) Applicant: Peter Miller, Wauconda, IL (US)

(72) Inventor: Peter Miller, Wauconda, IL (US)

(21) Appl. No.: 18/815,257

(22) Filed: Aug. 26, 2024

Related U.S. Application Data
(60) Provisional application No. 63/534,761, filed on Aug. 25, 2023.

(51) Int. Cl. F25D 23/02

(52) U.S. Cl. CPC F25D 23/02; F25D 2201/126

(57) ABSTRACT

An enhanced freezer door with an indent that runs in the same direction as the post and enables the enhanced freezer door to have a greater swing.

This application claims priority to U.S. Provisional Patent Application 63/534,761, Titled “Enhanced Insulated Door,” filed on Aug. 25, 2023, that is incorporated by reference herein.

### BACKGROUND OF THE INVENTION

### 1. Field of the Invention

This invention generally relates to doors and, more particularly, to insulated doors.

### 2. Related Art

### SUMMARY

Systems and methods consistent with the present invention provide an approach for a freezer door having a greater swing. The freezer door has notches running along the edge, allowing for greater swing.

Due to the thickness of an insulated freezer door, the swing of the door is often limited to only 90 degrees. This limited opening often creates problems with dollies, pallet jacks, and forklifts entering and exiting the freezer. Therefore, there is a need for methods and systems to create an insulated door with a greater swing.

Other methods, features, and advantages of the invention will become apparent to one with skill in the art upon examination of the following figures and detailed description. It is intended that all such additional methods, features, and advantages be included within this description, be within the scope of the invention, and be protected by the accompanying claims.

### BRIEF DESCRIPTION OF THE FIGURES

The components in the figures are not necessarily to scale, emphasis instead being placed upon illustrating the principles of the invention. In the figures, like reference numerals designate corresponding parts throughout the different views.

FIG. 1 illustrates a traditional freezer door compared to the enhanced freezer door in accordance with an example implementation of the invention.

FIG. 2 illustrates the enhanced freezer door with an extra 13 degrees of swing in accordance with an example implementation of the invention.

FIG. 3 illustrates a top view of the enhanced freezer door in accordance with an example implementation.

### DETAILED DESCRIPTION

The enhanced freezer door of the figures is created by making a frame, such as with aluminum or other materials. The frame is filled with insulation foam. The insulation form may be sculpted to create an indented region on one or both sides of the insulated freezer door. The door is then coated with a known polyurethane-type covering. This covering is preferably sprayed on, adding strength and rigidity to the door. a frame. The frame has a first freezer door panel with at least a first notch in a first freezer door panel, a foam-filled area in the frame, where the foam-filled area follows the first notch, where the first notch is positioned to approximate contact with the door jamb.

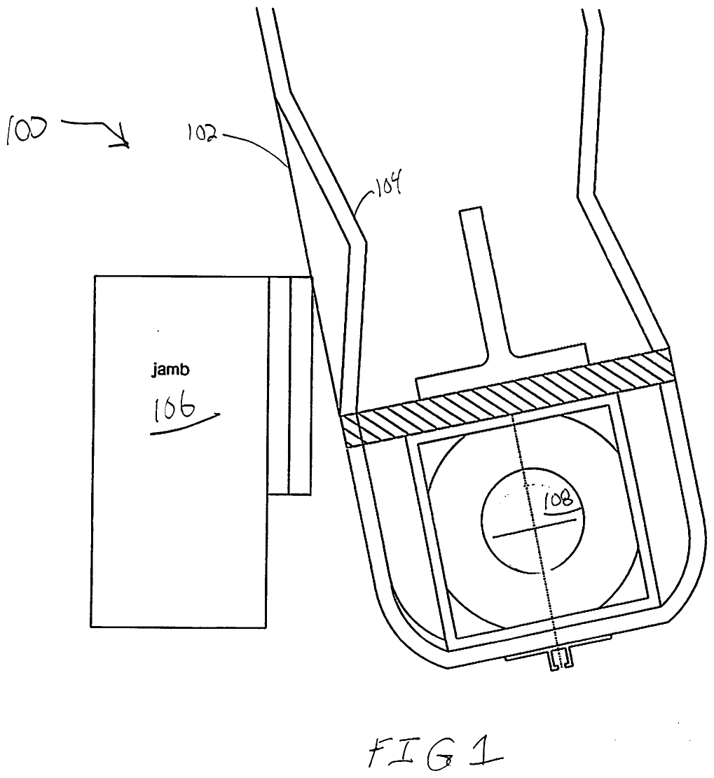

In FIG. 1, an illustration 100 of a traditional freezer door 102 is compared to the enhanced notched freezer door 104 in accordance with an example implementation of the invention. A traditional freezer door 102 has thick, insulated straight door panels. The problem with thick, straight door panels on a large freezer is that door 102 hits door jamb 106, which limits the door swing. This is especially true for bollard-supported doors (bollard 108). As the freezer door rotates and opens, it contacts the door jam 106.

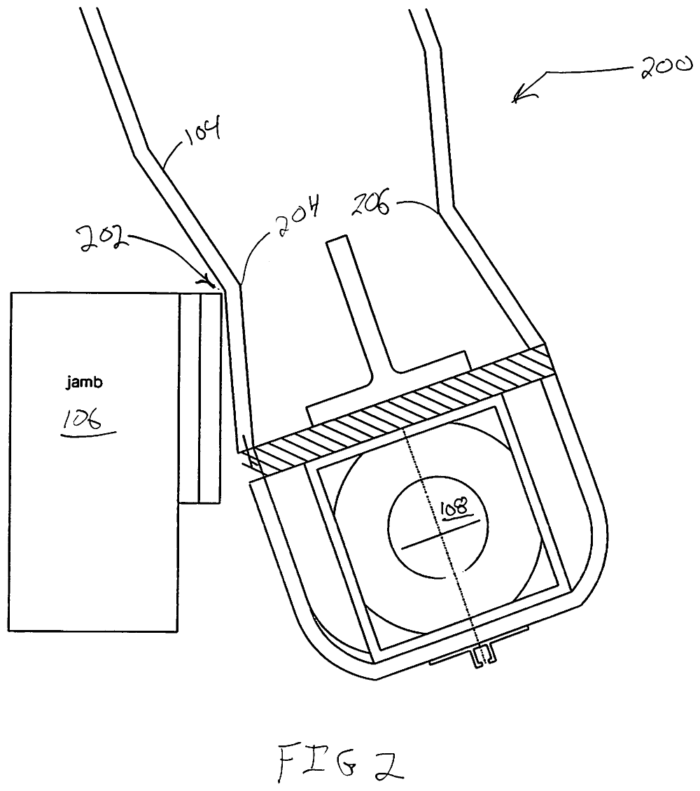

Turning to FIG. 2, an illustration of the enhanced freezer door 104 with an extra 13 degrees of swing 202 in accordance with an example implementation of the invention. In the current implementation, 13 degrees of additional swing is sufficient while maintaining enough structural strength and insulation. In the current implementation, freezer door 104 can swing both ways. Thus, a first notch 202 and second notch 202 opposite the first notch 202 are depicted. Only a first notch 202 is required if the freezer door only opens one way.

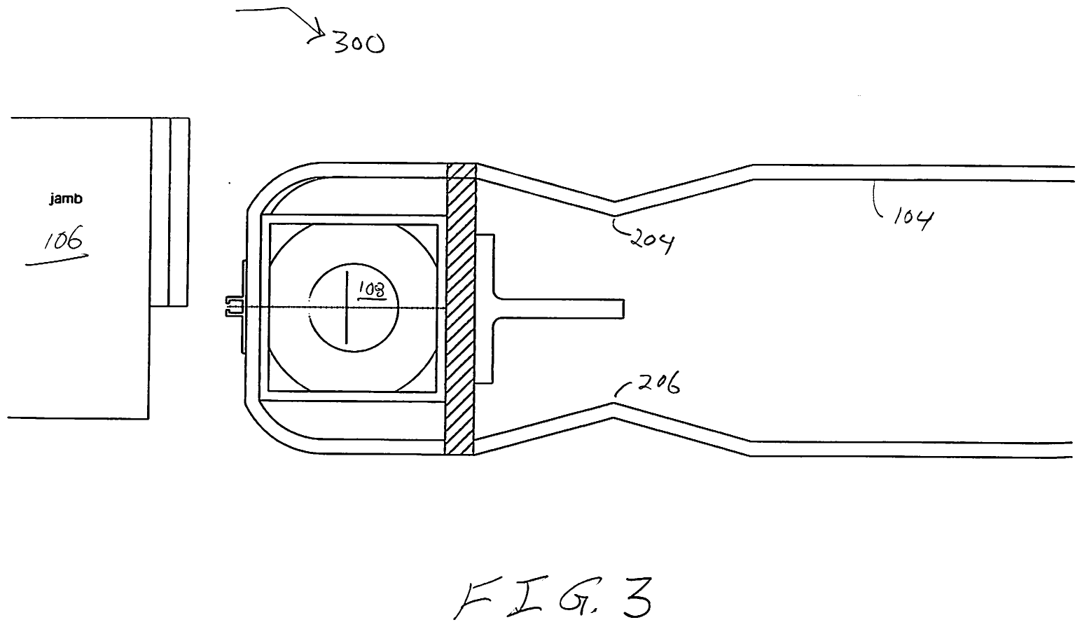

In FIG. 3, an illustration of a top view 300 of the enhanced freezer door 104 in accordance with an example implementation is depicted. The freezer door is in a closed position. As previously mentioned, the freezer door 104 maintains a sufficient thickness between the first notch 204 and the second notch 206 to maintain strength. However, internal supports may be used, such as frame support 302. Frame support 302 extends into the narrowest point between the first notch 204 and the second notch 206.

The foregoing description of an implementation has been presented for illustration and description. It is not exhaustive and does not limit the claimed inventions to the precise form disclosed. Modifications and variations are possible in light of the above description or may be acquired from practicing the invention. The claims and their equivalents define the scope of the invention.

What is claimed is:

1. An enhanced freezer door, comprising:
a frame;
at least a first notch in a first freezer door panel; and
a foam-filled area in the frame, where the foam-filled area follows the first notch, where the first notch is positioned to approximate contact a jamb.

2. The enhanced freezer door of claim 1, wherein the frame includes an internal support that extends behind the first notch.

3. The enhanced freezer door of claim 1, wherein a second notch in a second freezer door panel is formed opposite the first notch.

4. The enhanced freezer door of claim 3, wherein the frame includes an internal support that extends between the first notch and the second notch.

5. The enhanced freezer door of claim 4, wherein the enhanced freezer door turns on a bollard.

6. The enhanced freezer door of claim 4, wherein the first freezer door panel and second freezer door panel encase insulation.

7. A method for an enhanced freezer door, comprising:
forming a frame;
creating at least a first notch in a first freezer door panel; and
filling a foam-filled area in the frame, where the foam-filled area follows the first notch, where the first notch is positioned to approximate contact with a jamb.

8. The enhanced freezer door of claim 7, wherein the frame includes placing an internal support that extends behind the first notch.

9. The enhanced freezer door of claim 7, further includes forming a second notch in a second freezer door panel opposite the first notch.

10. The enhanced freezer door of claim 9, wherein the frame includes placing an internal support that extends between the first notch and the second notch.

11. The enhanced freezer door of claim 10, wherein the enhanced freezer door turns on a bollard.

12. The enhanced freezer door of claim 10, wherein the first freezer door panel and second freezer door panel encase insulation.
